(19) United States
(12) Patent Application Publication
(10) Pub. No.: US 2025/0346038 A1
(43) Pub. Date: Nov. 13, 2025

(54) INK CONTAINER

(71) Applicant: CANON KABUSHIKI KAISHA, Tokyo (JP)

(72) Inventors: MAKOTO WATANABE, Kanagawa (JP); MITSURU CHIDA, Kanagawa (JP); JUNICHIRO IRI, Kanagawa (JP)

(21) Appl. No.: 19/197,040

(22) Filed: May 2, 2025

(30) Foreign Application Priority Data
May 10, 2024 (JP) 2024-077161

(51) Int. Cl. B41J 2/175

(52) U.S. Cl. CPC B41J 2/17523; B41J 2002/17516

(57) ABSTRACT

An ink container configured to be attachable to and detachable from an apparatus main body of a liquid ejection apparatus includes: a channel configured to allow ink to flow in and out; and an ink containing portion formed of an elastic member and configured to contain the ink inside via the channel, in which a surface area in a state in which the ink containing portion contains the ink is at least twice as great as a surface area in a state in which the ink containing portion does not contain the ink.

### BACKGROUND

### Field of the Invention

The present disclosure relates to an ink container and specifically relates to an ink container including an elastic member.

### Description of the Related Art

Recently, waste plastic elimination and waste plastic reduction have been demanded to deal with environmental problems. Japanese Patent Laid-Open No. 2021-14091 (hereinafter, referred to as PTL 1) discloses an ink container in a form that has a great containing capacity to reduce the frequency of replacement and additionally that contains liquid in a bag formed of a flexible film such as aluminum lamination taking into consideration of easy handling.

However, in PTL 1, many plastic materials are used in the bag as the ink container, a connection member for attaching to and detaching from an apparatus main body, a handle member used to carry, and an container case that contains the ink container. For this reason, it is necessary to provide an ink container that can accommodate the demand of waste plastic elimination and waste plastic reduction.

### SUMMARY

An ink container according to an aspect of the present disclosure is an ink container configured to be attachable to and detachable from an apparatus main body of a liquid ejection apparatus, including: a channel configured to allow ink to flow in and out; and an ink containing portion formed of an elastic member and configured to contain the ink inside via the channel, in which a surface area in a state in which the ink containing portion contains the ink is at least twice as great as a surface area in a state in which the ink containing portion does not contain the ink.

Further features of the present disclosure will become apparent from the following description of exemplary embodiments with reference to the attached drawings.

### BRIEF DESCRIPTION OF THE DRAWINGS

FIGS. 1A and 1B are schematic views of an ink container according to a first embodiment;

FIGS. 2A and 2B are schematic views of the ink container according to a second embodiment;

FIGS. 3A and 3B are schematic views of the ink container according to a third embodiment;

FIG. 4 is a diagram illustrating a configuration example 1 in a case where the ink container according to the first embodiment is connected to an ink ejection apparatus;

FIG. 5 is a diagram illustrating a configuration example 2 in a case where the ink container according to the first embodiment is connected to an apparatus main body;

FIG. 6 is a diagram illustrating a configuration example 3 in a case where the ink container according to the first embodiment is connected to the apparatus main body; and

FIG. 7 is a diagram illustrating a configuration example 4 in a case where the ink container according to the first embodiment is connected to the apparatus main body.

### DESCRIPTION OF THE EMBODIMENTS

Hereinafter, embodiments of the present disclosure are described with reference to the drawings. Note that, the same configurations are described with the same reference numerals provided. Additionally, relative positions, shapes, and the like of constituents described in the embodiments are merely examples.

### First Embodiment

A technique described in the present specification may contribute to realization of a sustainable society such as a decarbonized/recycling society. In the present embodiment, an ink container that can achieve plastic reduction is described as the technique that may contribute to realization of a sustainable society.

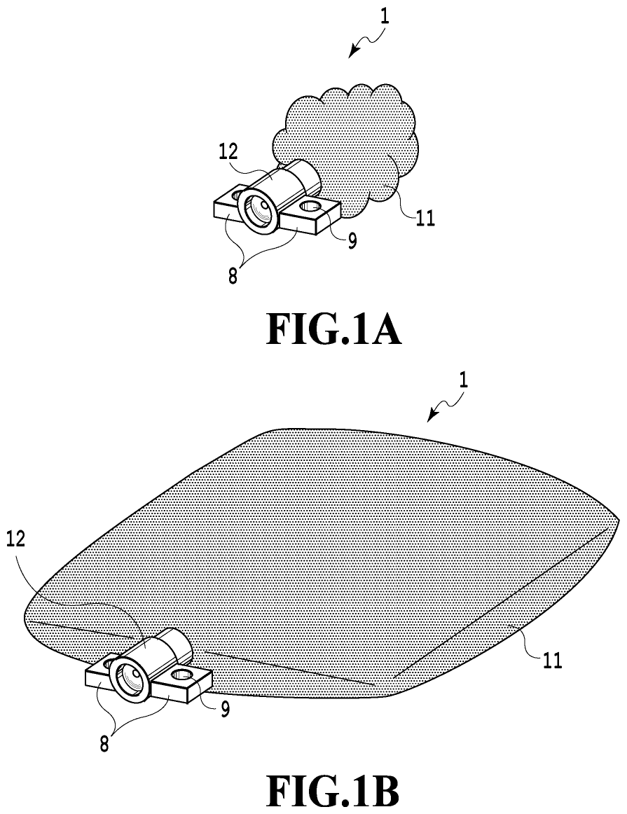

FIGS. 1A and 1B are schematic views of an ink container in the present embodiment. FIG. 1A is a diagram of the ink container before ink filling, and FIG. 1B is a diagram of the ink container after ink filling. An ink container 1 includes an ink containing portion 11 to contain ink, a channel 12 communicating with the ink containing portion 11, a pair of protrusions 8 extending from the channel 12 in a radial direction, and a positioning hole 9 provided in the pair of protrusions 8. The channel 12 is arranged in a spout protruding from the ink containing portion 11, and the spout is provided with a positioning unit to fix the ink container to a liquid ejection apparatus. In the present embodiment, the channel 12 is arranged in the spout protruding from the ink containing portion 11; however, it is not limited thereto, and the channel may be arranged in a spout protruding from the liquid ejection apparatus. The channel is connected to the center of one of four sides of the ink containing portion 11. In the present embodiment, the channel 12 is in the center of one of the four sides of the ink containing portion 11; however, it is not limited thereto, and the channel 12 may be connected to an arbitrary position. The channel 12 is adhered to the ink containing portion 11 with heat sealing.

The ink containing portion 11 is formed of an elastic member. The ink containing portion 11 is in a contraction state before the filling with the ink (see FIG. 1A), and after the filling with the ink, the state transitions to an expansion state (see FIG. 1B). In this case, a surface area in a state in which the ink containing portion 11 contains the ink is at least twice as great as a surface area in a state in which the ink containing portion 11 does not contain the ink. Thus, it is possible to fill the ink containing portion 11 with a lot of ink.

The ink containing portion 11 is desirable to be formed of a flexible material with a smaller degree of elasticity than that of a publicly-known plastic material. If the degree of elasticity of the ink containing portion is high, the ink containing portion itself becomes hard. Therefore, the ink containing portion does not expand even in a case where the ink containing portion is filled with the ink, and it is impossible to fill the ink containing portion with the ink.

The elastic member of the ink containing portion 11 includes a material of a synthetic rubber system, and a material that contains any one of the following, selected from fluorine-contained rubber, nitrile rubber, butyl rubber, chloroprene rubber, silicone rubber, and the like is used, for example. In the present embodiment, since natural rubber that is known as common rubber has excellent stretchability but less heat resistance and less chemical resistance, a material that contains any one of the following, selected from fluorine-contained rubber, nitrile rubber, butyl rubber, chloroprene rubber, silicone rubber, and the like is used. With the ink container 1 being formed of the above-described elastic member, it is possible to reduce the air in the ink container 1 as much as possible during the ink filling.

A film thickness of the elastic member of the ink containing portion 11 is desirably within a range of about 0.1 mm or greater and 0.3 mm or smaller. With the film thickness of the elastic member within a range of 0.1 mm or greater and 0.3 mm or smaller, it is possible to prevent easy breakage even in a case where the ink containing portion is changed during the ink filling.

With the ink filling, the ink containing portion 11 has a rectangular shape as the shape in a planar view, and the entire ink containing portion 11 has a substantially cuboid shape. Additionally, in a case where the ink containing portion 11 is connected to an apparatus main body of the ink ejection apparatus via the channel 12 and the ink in the ink containing portion 11 is reduced, it is possible to reduce also the surface area of the ink containing portion 11 by the amount of the reduction of the ink, accordingly. Thus, since the ink container 1 is downsized, it is possible to improve the disposability and the usability of the ink more than that of a conventional ink container.

### Second Embodiment

A second embodiment according to the present disclosure is described. Note that, description of a portion that is duplication of the first embodiment is omitted.

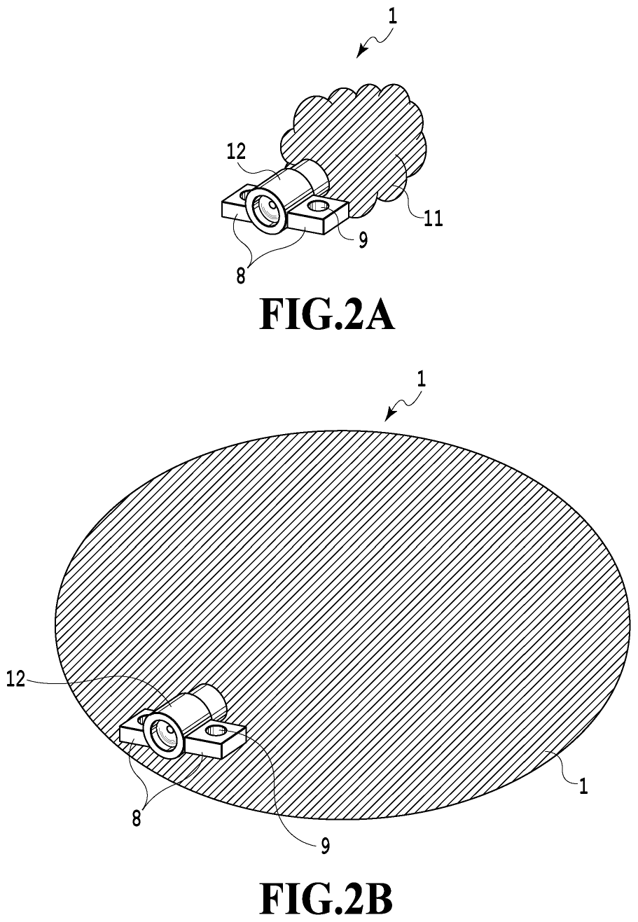

FIGS. 2A and 2B are a schematic views of the ink container in the present embodiment. FIG. 2A is a diagram of the ink container before ink filling, and FIG. 2B is a diagram of the ink container after ink filling. With the ink filling, the ink container 1 according to the second embodiment has a circular shape as the shape in a planar view. Additionally, in a case where the ink containing portion 11 is connected to the apparatus main body of the ink ejection apparatus via the channel 12 and the ink in the ink containing portion 11 is reduced, it is possible to reduce also the surface area of the ink containing portion 11 by the amount of the reduction of the ink, accordingly.

Thus, since the ink container 1 is downsized, it is possible to improve the disposability and the usability of the ink more than that of the conventional ink container. Note that, in the present embodiment, since the shape of the ink containing portion 11 in a planar view is a circular shape, there is a concern of occupation of a main body space in a case where the ink containing portion 11 is connected to the ink ejection apparatus main body. Therefore, it is desirable to use the present embodiment for an ink container with a small capacity.

### Third Embodiment

A third embodiment according to the present disclosure is described. Note that, description of a portion that is duplication of the first embodiment is omitted.

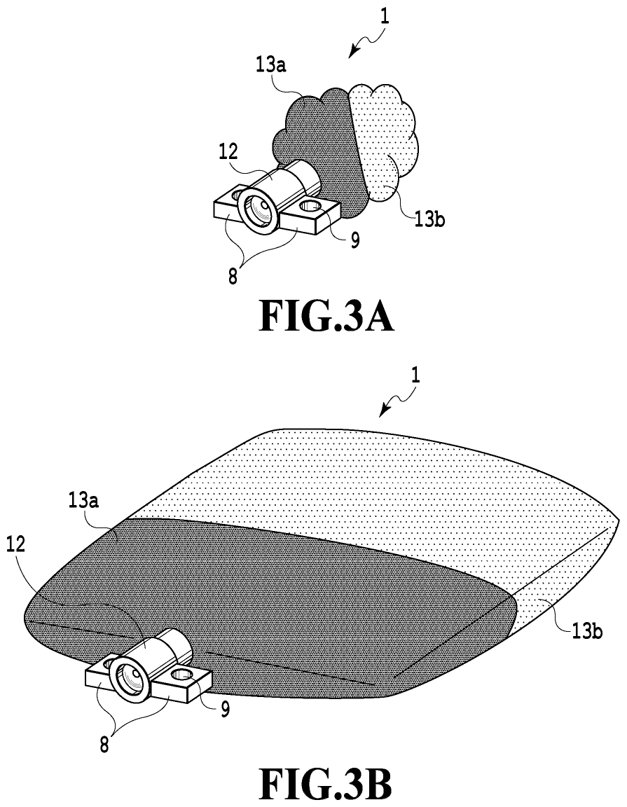

FIGS. 3A and 3B are schematic views of the ink container in the present embodiment. FIG. 3A is a diagram of the ink container before ink filling, and FIG. 3B is a diagram of the ink container after ink filling. The ink container 1 in the third embodiment includes an ink containing portion 13 to contain the ink.

The ink containing portion 13 includes a first ink containing portion 13a and a second ink containing portion 13b. In the present embodiment, the channel 12 is connected with the first ink containing portion 13a. The ink containing portion 13 is formed of multiple materials having different degrees of elasticity. The multiple materials of the ink containing portion 13 have a higher degree of elasticity on a side distal to the channel 12 than the degree of elasticity on a proximal side. In the present embodiment, the degree of elasticity of the first ink containing portion 13a is different from that of the second ink containing portion 13b, and the degree of elasticity of the first ink containing portion 13a is lower than that of the second ink containing portion 13b. Thus, the ink remaining in the ink containing portion 13 is pushed onto the channel 12 side actively, and the disposability of the ink is further improved than that of the above-described embodiment.

Note that, although the ink containing portion 13 includes the first ink containing portion 13a and the second ink containing portion 13b in the present embodiment, it is not limited thereto, and multiple containing units may be included.

### (Configuration Example 1 in Case of Connecting to Liquid Ejection Apparatus Main Body)

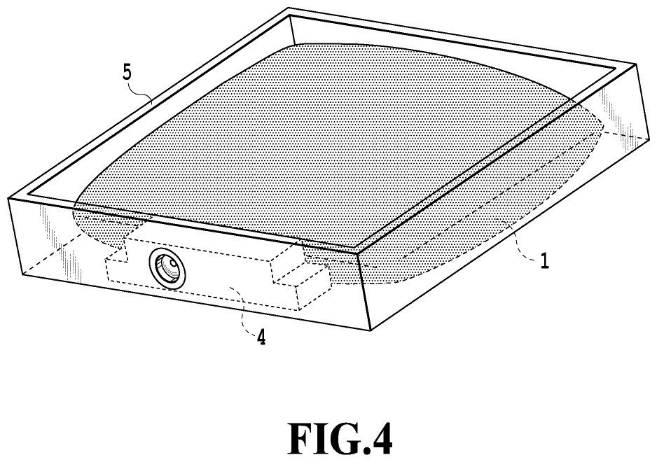

FIG. 4 is a diagram illustrating a configuration example 1 in a case where the ink container 1 according to the first embodiment is connected to the ink ejection apparatus.

The ink ejection apparatus includes a spout 4 connected with the ink container 1 and an ink container case 5 that contains the ink container 1.

The spout 4 is connected so as to embed the channel 12 of the ink container 1 therein. Therefore, it is possible to supply the ink ejection apparatus with the ink in the ink container 1 while fixing the channel 12.

The ink container case 5 is formed of a publicly-known case material, which is plastic, for example. Additionally, the ink container case 5 contains the ink container 1 according to the first embodiment. Thus, it is possible to prevent an external effect on the ink container 1.

### (Configuration Example 2 in Case of Connecting to Liquid Ejection Apparatus Main Body)

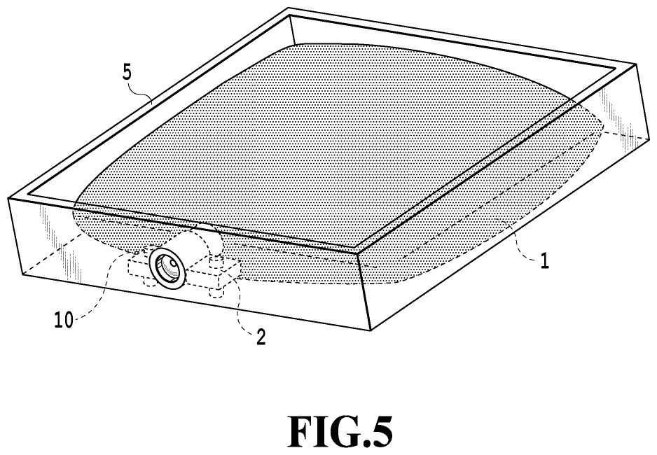

FIG. 5 is a diagram illustrating a configuration example 2 in a case where the ink container 1 according to the first embodiment is connected to the ink ejection apparatus. Note that, description of a portion that is duplication of the configuration example 1 is omitted.

Unlike the configuration example 1, in the configuration example 2, the ink container 1 is attached to the ink container case 5 without including the spout 4 that is connected to the channel 12 in terms of waste plastic reduction.

The ink container case 5 includes a spout channel positioning pin 10. The channel 12 fits the positioning hole 9 to the spout channel positioning pin 10 provided in the ink container case 5. Thus, it is possible to fix the ink container 1 in the ink container case 5. In the present embodiment, the positioning hole 9 of the spout is provided in the ink container 1; however, it is not limited thereto, and the positioning hole 9 may be provided in the ink container case 5.

### (Configuration Example 3 in Case of Connecting to Liquid Ejection Apparatus Main Body)

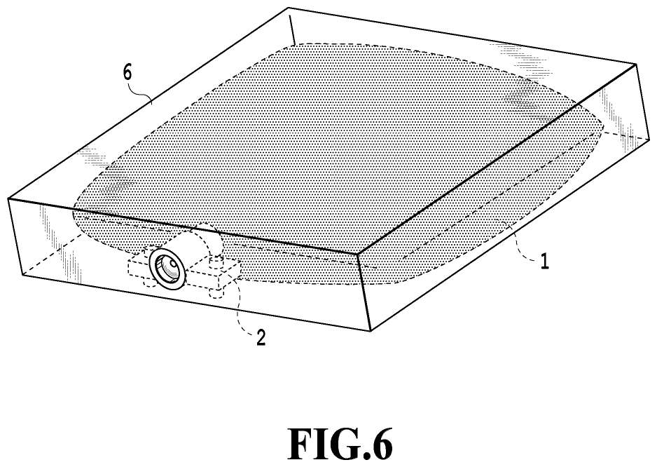

FIG. 6 is a diagram illustrating a configuration example 3 in a case where the ink container 1 according to the first embodiment is connected to the ink ejection apparatus.

Unlike the configuration example 2, the configuration example 3 does not use the conventional ink container case 5 but an ink container box 6. As the ink container box 6, cardboard and the like may be used in terms of waste plastic reduction, for example. Additionally, in the ink container box 6, the ink container 1 to which the channel 12 of the ink container 1 is attached is attached. In a case of the attachment, as with the configuration example 2, the spout channel positioning pin 10 is fitted to the positioning hole 9 of the channel 12 to be fixed.

With the above-described configuration, it is possible to reduce use of plastic to meet the environmental regulation.

### (Configuration Example 4 in Case of Connecting to Liquid Ejection Apparatus Main Body)

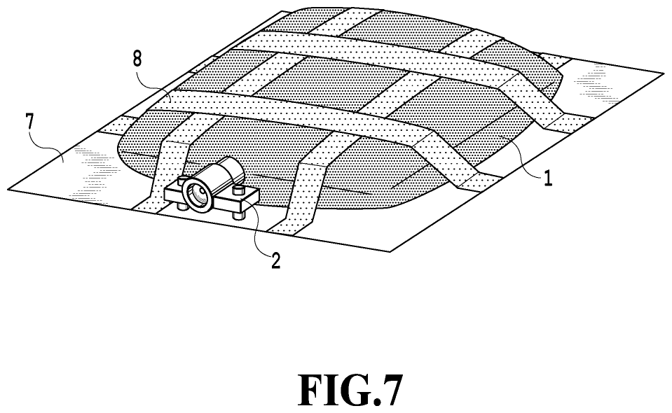

FIG. 7 is a diagram illustrating a configuration example 4 in a case where the ink container 1 according to the first embodiment is connected to the ink ejection apparatus.

Unlike the configuration example 2 and the configuration example 3, the configuration example 4 does not use the conventional ink container case 5 and the ink container box 6 but an ink container tray 17.

The ink container 1 is placed on the ink container tray 17. As with the configuration example 2, the channel 12 is fixed with the spout channel positioning pin 10 being fitted to the positioning hole 9. The ink container 1 is fixed by a frame 18 to fix the ink container. In addition to the fixation of the ink container 1, the frame 18 also suppresses deformation of the ink container 1 to the opposite side of the ink container tray 17. In the present configuration example, the ink container 1 does not slip out of the frame 18 to fix the ink container as illustrated in FIG. 7 even in a case of the contraction. As the ink container tray 17, cardboard may be used in terms of further reduction of waste plastic.

Thus, with the frame 18 being provided on the ink container tray 17, deformation of the ink container in a direction opposite to the ink container tray 17 is suppressed.

Note that, although the configuration examples 1 to 4 describe examples in which the ink container 1 is contained in the ink container case 5 and the like according to the first embodiment, as a matter of course, the ink container case 5 and the like can also contain the ink container 1 in another shape including that in the second embodiment and the third embodiment.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-077161, filed May 10, 2024, which is hereby incorporated by reference wherein in its entirety.

What is claimed is:

1. An ink container configured to be attachable to and detachable from an apparatus main body of a liquid ejection apparatus, comprising:
a channel configured to allow ink to flow in and out; and
an ink containing portion formed of an elastic member and configured to contain the ink inside via the channel, wherein
a surface area in a state in which the ink containing portion contains the ink is at least twice as great as a surface area in a state in which the ink containing portion does not contain the ink.

2. The ink container according to claim 1, wherein
the ink containing portion is a flexible material with a smaller degree of elasticity than that of a plastic material.

3. The ink container according to claim 1, wherein
the elastic member is a material containing any one of the following, selected from fluorine-contained rubber, nitrile rubber, butyl rubber, and chloroprene rubber.

4. The ink container according to claim 1, wherein
a film thickness of the elastic member is within a range of 0.1 mm or greater and 0.3 mm or smaller.

5. The ink container according to claim 1, wherein
a shape of the ink containing portion in a planar view in a state of containing the ink is a rectangular shape or a circular shape.

6. The ink container according to claim 1, wherein
the channel is arranged in a center of one side of the ink containing portion.

7. The ink container according to claim 1, wherein
the ink containing portion is formed of a plurality of materials having different degrees of elasticity.

8. The ink container according to claim 1, wherein
a plurality of materials of the ink containing portion have a higher degree of elasticity on a side distal to the channel than a degree of elasticity on a proximal side.

9. The ink container according to claim 1, wherein
the channel is arranged in a spout protruding from the ink containing portion, and the spout is provided with a positioning unit to fix the ink container to the liquid ejection apparatus.

10. The ink container according to claim 1, wherein
the liquid ejection apparatus is provided with a tray on which the ink container is placed and a frame to fix the ink container to the tray.
